(19) United States
(12) Patent Application Publication
(10) Pub. No.: US 2025/0041774 A1
(43) Pub. Date: Feb. 6, 2025

(54) CLOSED LOOP FILTRATION SYSTEM FOR MICROPLASTIC POLLUTION

(71) Applicant: MOBY Filters LLC, New York, NY (US)

(72) Inventors: Jonathan Carl Ronn, New York, NY (US); Siddhant Srivastava, Jersey City, NJ (US)

(21) Appl. No.: 18/785,885

(22) Filed: Jul. 26, 2024

Related U.S. Application Data
(60) Provisional application No. 63/530,931, filed on Aug. 4, 2023.

(51) Int. Cl. B01D 35/143; B01D 27/14

(52) U.S. Cl. CPC B01D 35/143; B01D 27/14; B01D 2201/4069; B01D 2201/4084

(57) ABSTRACT

A closed loop system for and method of capture, recycling, and safe disposal of microplastics, applied to residential and commercial textile washing and drying machine devices is proposed. The closed loop system allows for effective capture, processing and recycling, or safe disposal of microplastic material. The system employs an easy-to-use filter design, optimized to capture microplastics within the device or through air or water discharge lines, followed by post-processing of filter devices where the captured microplastic residue is physically or chemically processed for either recycling the captured microplastic residue into new filters or new products, or alternatively the captured microplastic residue can be locked into a safe matrix for disposal, wherein leaching from landfills into the environment is minimized or eliminated.

### CROSS-REFERENCE TO RELATED APPLICATIONS

The present patent application claims the priority benefit of U.S. provisional patent application No. 63/530,931 filed Aug. 4, 2023, the disclosure of which is incorporated by reference herein.

### BACKGROUND OF THE INVENTION

### 1. Field of the Invention

The present disclosure is generally related to microplastic filtration, use and reuse, water, soil, and air quality, regenerative design, environmental protection, and/or global health.

### 2. Description of the Related Art

Microplastics (MPs) have been identified in every ecosystem on Earth. Ecologically detrimental and toxic to humans, these small particles travel up the food chain and are eventually ingested by people. Recent studies have found that every week an average person ingests the plastic weight of one credit card (5 g of plastic). Once ingested, the released toxins like persistent organic pollutants (POPs), heavy metals, and chemicals like bisphenol A can cause tissue inflammation, cardiopulmonary responses, blood clots, stinted brain development, weakened immune systems, cancerous cells, and neurotoxicity. The largest contaminator of MPs, 34.8%, comes from laundering of synthetic textiles. A 2023 market report from The Business Research Company estimates the global synthetic fibers market will grow from $161.11 billion in 2022 to $174.16 billion in 2023 at a compound annual growth rate (CAGR) of 8.1%. The synthetic fibers market is expected to grow from $231.33 billion in 2027 at a CAGR of 7.4%. The synthetic fibers market consists of the sales of rayon, microfiber, and spandex synthetic fibers. By 2030 it is expected that the consumption of polyester will be approximately three times that of cotton fiber. Thus, the increased usage of synthetic fibers in end-user industries is expected to drive the synthetic fiber market. Synthetic fibers are non-biodegradable and affect the environment negatively. Fragmentation and withering of large synthetic fibers generate microplastics, which affect the ecosystem. Any plastic that is less than 5 mm in length is considered microplastic. Plastic fragments may be nanoplastics, even smaller than microplastics, and may go undetected in the ecosystem. Microplastics act as a medium through which harmful chemicals and micro-organisms enter the human body easily.

Microplastics have also been shown to persist in the environment and therefore cause an escalating problem by entering watersheds, wastewater treatment facilities, and surface waters, and thus continue accumulating in living organisms that live in, use, or drink the water unless the cycle is broken. Capture and disposal of microfibers in landfills may result in escape of microfibers or leaching of materials containing the persistent contaminant. Therefore, a solution is needed to effectively capture, upcycle, and reuse the material, or alternatively fix or lock the microfibers into a matrix or structure that will not leach and re-contaminate the environment.

Capturing and recycling microplastics presents a significant challenge due to their diminutive size, but numerous innovative methods are under development to tackle this issue. One of the more traditional approaches involves the use of advanced filtration systems, like those in certain wastewater treatment facilities, that can capture microplastics before their release into water bodies. The same concept can be applied to washing machines by installing filters to catch microplastics shed from clothing. An alternative, high-tech solution is pyrolysis, a process where materials are broken down by high temperatures in an oxygen-free environment, converting microplastics back into usable oil or gas. Scientists are also exploring regenerative design, nature-based and bio-based methods, utilizing microorganisms known to degrade or consume plastics, as well as enzymes and fungi these organisms produce, to break down microplastics. Some researchers propose the collection and use of microplastics as a component in construction materials or consumer goods. On a smaller scale, nanotechnology offers promise, with certain nanomaterials like graphene oxide exhibiting an ability to absorb or capture microplastics, potentially usable in filtration systems. Another proposed method involves the use of infrared radiation to identify and separate microplastics from other materials, facilitating their potential recycling. Also, given that many plastics are lighter than water, buoyancy and flotation techniques can be deployed to separate microplastics from denser materials.

In the present invention, the focus is on capture of microplastics from washing/drying machines which is then reused to create “new” items containing reclaimed materials, or alternatively treated or packaged for safe disposal.

Microplastics are tiny particles of plastic material, typically defined as being less than 5 millimeters in diameter according to the U.S. National Oceanic and Atmospheric Administration. They come in a wide range of shapes, including fragments, films, fibers, microbeads, and pellets, and their composition can vary widely as well, reflecting the diversity of plastic materials. These can include polyethylene, polypropylene, polystyrene, polyvinyl chloride (PVC), and polyethylene terephthalate (PET), among others. Microplastics can be primary, manufactured intentionally for use in products such as cosmetics, industrial abrasives, and drug delivery systems, or secondary, formed by the breakdown of larger plastic debris in the environment. Both forms of microplastics are pervasive in terrestrial, atmospheric, and aquatic environments and can have adverse impacts on all life forms, organisms, and ecosystems due to their durability and potential to transport pollutants.

Despite changes in regulations, many beauty products, such as exfoliants and toothpaste, still contain microplastics such as abrasives or fillers, serving as a common source of microplastic pollution. Another major source of microplastics is synthetic fabrics like polyester and nylon, which release microfibers, a form of microplastic, into the water supply when they are washed. Further, the breakdown and degradation of plastic packaging materials into smaller particles results in the formation of microplastics. Industrial scrubbers, which often utilize plastic pellets as abrasive media, can also contribute to microplastic pollution upon discharge into the environment. Fishing gear, such as nylon nets and polypropylene ropes, can degrade over time, releasing microplastics into the ocean. Microplastics can also be released into the environment from unexpected sources like automotive tires; as they wear down, tires, which often contain synthetic rubber, can release these tiny particles into the environment. Similarly, the breakdown of painted road markings, and footwear, such as sneakers, can lead to the formation of microplastics. Urban environments, containing a multitude of plastic materials that can degrade into microplastics, contribute to city dust being a source of these pollutants. Artificial turf, made from plastic materials, can shed microplastics as it weathers. Additionally, despite filtration efforts, wastewater treatment plants can release microplastics from both industrial and residential wastewater into the environment. Agricultural plastics, such as the degradation of plastic mulch films used in agriculture, plastic tarps, and farmed fish foods can also result in microplastics. Furthermore, marine coatings, such as anti-fouling and other types used on ships, can degrade over time, producing microplastics. The degradation of plastic waste in landfills generates microplastics, which can leach into groundwater. Household dust is another source, where the wear and tear of indoor plastic materials, including furniture and electronics, contribute to the microplastic content. Many household cleaning products and detergents also contain plastic fragments or microbeads as abrasive agents, leading to further pollution. Plastic production and handling facilities also contribute to this issue; plastic pellets, also known as nurdles, can be spilled and lost during handling and transport. Cigarette filters, made from cellulose acetate, a type of plastic, break down into microplastics, contributing to pollution. The textile manufacturing industry is also a producer of microplastic pollution as a byproduct of processing synthetic fibers, or coating or dyeing natural fibers. The filament used in 3D printing, often made of plastic, generates microplastics during the printing process. Finally, the breakdown of plastic construction materials, such as PVC pipes and insulation, results in microplastic pollution, making it a widespread and pervasive environmental issue.

A wide variety of microfiber types and blends exist, many of which are partially or fully synthetic, including polyester microfibers, nylon microfibers, polypropylene microfibers, microfiber blends, split microfibers, nano microfibers, electrospun microfibers, microfiber yarns, biodegradable microfibers, and composite microfibers. Natural fibers, synthetic fibers, and blends may be coated with PFAS or other chemicals, or dyed, which results in the emission of those chemicals into the environment when the fibers shed. This shedding of natural and synthetic fibers therefore leads to the additional waste of chemicals into the environment.

Polyester microfibers are the most common type of synthetic microfiber and are known for their durability, resilience, and ease of care. They can be made in various shapes and sizes to meet specific end-use requirements, and are widely used in the textile industry, in products ranging from clothing to upholstery. Nylon microfibers are a type of synthetic microfiber known for their excellent tensile strength, elasticity, and abrasion resistance. They are often used in products that need to withstand a lot of wear and tear, such as sportswear, automotive parts, and industrial filters. Known for their hydrophobic properties and excellent chemical resistance, Polypropylene fibers are often used in outdoor and marine textiles. These fibers are also very lightweight, which makes them suitable for products like thermal insulation and non-woven fabrics. Microfiber blends refer to microfibers that are blended with other types of fibers, either synthetic or natural, to create a material with the desired properties. For example, cotton-polyester fiber blends are often used in bed linens and towels, providing the comfort of cotton with the durability of polyester. The microfiber used in these applications may shed over time to release microfiber particles, fragments, or pieces into the environment. Nano microfibers (or micro nanoplastics or MNPs) refer to microfibers that are even smaller than typical microfibers, in the nanometer range. There is a high correlation between PM 2.5 and microplastics in the environment; microplastics have been shown to adsorb airborne contaminants. Particulate matter contains microscopic solids or liquid droplets that are so small that they can be inhaled and cause serious health problems. Some particles less than 10 micrometers in diameter can get deep into the lungs and some may even reach the bloodstream. Of these, the fine particles or PM2.5, pose the greatest risk to health. These fibers have increased surface area and can offer better performance in terms of advanced filtration and absorption. They are often used in high-tech applications such as air and water filtration, and in medical devices. Composite microfibers are made by combining two or more different types of materials. These materials can be either in the form of a core-shell structure, where one material forms a core that is surrounded by another material, or they can be mixed together. Composite microfibers can have improved properties, such as strength, stiffness, or functionality, and can be tailored for specific applications.

In the present invention, the term microplastics includes microplastics and blends that may include but are not limited to microfibers, nanofibers, nanoplastics, and other synthetic or natural materials.

### SUMMARY OF THE CLAIMED INVENTION

Embodiments of the claimed invention include closed-loop systems and methods for capture, recycling, and safe disposal of microplastics, applied to residential and commercial textile washing and drying machine devices is proposed. The closed loop system may allow for effective capture, processing and recycling, or safe disposal of microplastic material. The system may employ an easy-to-use filter design, optimized to capture microplastics within the device or through air or water discharge lines, followed by post-processing of filter devices where the captured microplastic residue is physically or chemically processed for either recycling the captured microplastic residue into new filters or new products, or alternatively the captured microplastic residue can be locked into a safe matrix for disposal, wherein leaching from landfills into the environment is minimized or eliminated.

### BRIEF DESCRIPTIONS OF THE DRAWINGS

FIG. 1 illustrates an exemplary closed loop system for capturing microplastics.

FIG. 2 is a flowchart illustrating an exemplary method for capturing microplastics.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

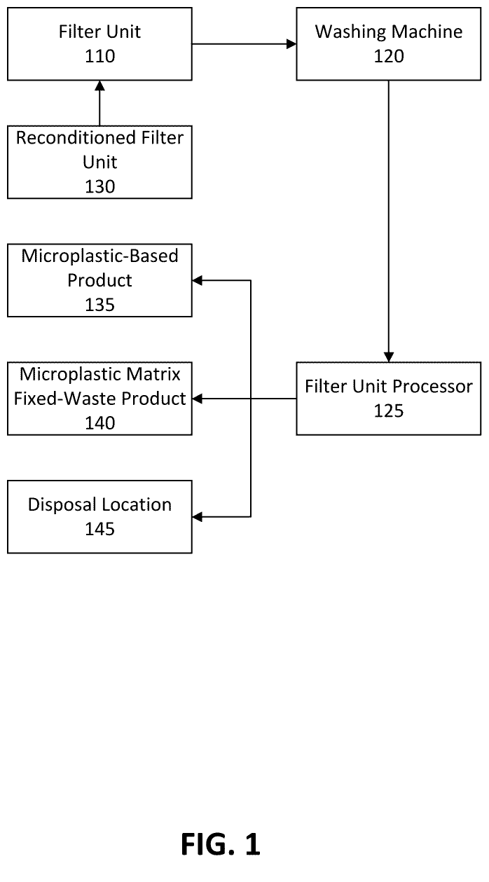

FIG. 1 describes a system for a closed loop system for capture and reuse of microplastics. A “closed-loop” system in product use, recycle, and reuse may refer to a regenerative process where waste materials are collected, processed, and reintegrated into the production cycle. This model may minimize the need for new raw material inputs and waste outputs, thereby creating a sustainable cycle of resource use and reuse that contributes to circular economy objectives. Closed loop may alternately be defined as a ‘circular’ or ‘zero waste’ system, signifying an efficient and self-sustaining cycle where materials are continually repurposed and recycled, thereby minimizing waste and the need for fresh resources. Washing/drying machine 105 may be an appliance or device that removes soil, stains, and other unwanted material from textile articles, most commonly clothing or apparel. Apparel may further include bedding, footwear, outerwear, intimate apparel, accessories like belts, shoelaces, etc.

Washing/drying machine 105 may utilize controlled kinetic and fluid dynamics. Washing/drying machine 105 may be made of a durable housing encasing a rotating drum, often with internal baffles, that is structurally designed to sustain the forces generated during high-speed rotation. The drum may receive the laundry load and water, often heated to variable temperatures depending on the selected wash cycle. Detergents or cleaning agents may be introduced to facilitate the emulsification and suspension of dirt particles. The wash cycle may involve mechanical agitation generated by the rotational movement of the drum, providing the friction necessary to dislodge soil from the fabric. In conjunction, a pump system may extract the effluent, and a centrifugal spin or tumble cycle may be applied to extract as much water as possible from the washed textile. Washing/drying machine 105 may be programmatically controlled, typically using microprocessors, to vary cycle types, durations, and intensity according to user-defined settings, providing a tailored approach to cleaning requirements.

Washing/drying machine 105 may be configured as a top-loading machine, which may employ an agitator or impeller mechanism to facilitate the turbulent motion required for soil removal, or washing/drying machine 105 may be a front-loading machine, which may leverage the force of gravity in conjunction with a horizontally mounted drum, to achieve a tumbling action. Washing/drying machine 105 may be a high-efficiency (HE) washer, which may be either top-loading or front-loading, and may be engineered with advancements such as variable-speed motors and specialized drum motions, to optimize cleaning performance with reduced water and energy consumption. Washing/drying machine 105 may be either a residential (home) device, or may be a commercial-grade unit, designed with robust components and higher-capacity drums to endure the rigors of extended, frequent use. In a commercial setting, multiple washing/drying machine 105 units may be provided together and defined as one unit, in locations that include but are not limited to laundromats, hotels and resorts, hospitals and healthcare facilities, restaurants and cafeterias, spas and salons, fitness centers and gyms, nursing homes and assisted living facilities, cruise ships, prisons and correctional facilities, educational institutions, manufacturing facilities, textile and dye houses or mills, military bases, airlines, event and conference centers, theatres and performing arts centers, fire and police stations, cleaning companies, veterinary clinics and animal shelters, hostels, sports teams and athletic facilities, or other businesses that require washing/drying of textiles.

In another embodiment, washing/drying machine 105 may be a textile dryer that employs a combination of heat, airflow, and mechanical action to expeditiously remove moisture from textiles, in either a water-based or a dry-cleaning solvent-based system. In this embodiment, washing/drying machine 105 may consist of a rotating drum, called the tumbler, where the garments are placed. The heating element within washing/drying machine 105 may raise the temperature of the air, which in turn may cause the water within the textiles to evaporate into steam. Concurrently, a blower or fan may circulate this hot air through the tumbler to ensure an even distribution of heat. This heated air may then be expelled from washing/drying machine 105 through an exhaust vent, while a lint trap may filter out particulates and fibers detached during the drying process. Sensors within washing/drying machine 105 may monitor the humidity level to modulate the heat and air circulation, optimizing energy usage and preventing the garments from excessive wear or shrinkage.

In yet another embodiment, washing/drying machine 105 may be a combination of functions to both wash and dry textile. In this embodiment, washing/drying machine 105 may integrate the functionality of a washing machine and a dryer into a single unit. Washing/drying machine 105 may be vented or ventless. A vented unit may operate similarly to a traditional front-loading washer and dryer, where textiles may be washed via tumbling with water and soap, then spun to remove excess water. During the drying cycle, air from the room may be heated and circulated with the clothes, picking up moisture and creating steam that may exit through a vent, while new air may be taken in and heated for the process to restart. A ventless unit may use a condensing drying system that functions like a dehumidifier. Wet clothes in the drum may have air heated around them, which may pick up moisture as the drum spins. This humid air may then be circulated through a cooled condensing chamber, transforming the moisture into liquid form. This condensation may leave the unit through a drainage tube, and the dry, hot air may be recirculated with the clothes.

A filter unit 110 is a device designed to capture and remove impurities, such as lint, microfibers, and microplastics, or other waste from the washing process, from the water during the wash and rinse cycles, thereby preventing these materials from entering the wastewater stream and mitigating potential damage to the machine and downstream plumbing, wastewater treatment plants, septic tanks, leakage from systems or to the air/atmospheric and terrestrial environments. Styles of filter unit 110 may include but are not limited to screen mesh inline filters, cartridge inline filters, multistage inline filters, hybrid inline filters, or smart inline filters. Filter unit 110 may be constructed from durable, water-resistant materials such as stainless steel, polypropylene, or nylon mesh, and may be created in configurations to best suit the washing machine design and intended functionality. In one example, filter unit 110 may be a cylindrical, conical, square, or rectangular, flat, disc, fin, windsock, balloon, or spherical shape that either captures or attracts fibers, or both. Filter unit 110 may be made of virgin materials or may be a product of the present invention. Thus, filter unit 110 may include newly manufactured products, or may also include products that may contain recycled material, such as reconditioned filter unit 130.

In another example, filter unit 110 may consist of a frame that contains a removable cartridge, pod, bag, or canister (or multiples of these formats) specifically designed to fit or attach to a specific area of washing/drying machine 105, such as the interior drum holes, affixed to the agitator, or fins. Filter unit 110 may have a specific design, orientation, mesh size and weave of materials optimized for microplastics capture within a particular model of washing/drying machine 105. Filter unit 110 may be designed to be taken out of a frame or housing for treatment and recycling after use, or alternatively the entire filter unit 110, including the frame or housing, may be designed for treatment and recycling together. In some examples, filter unit 110 may be designed for sustained use by providing multiple filter chambers that may rotate or automatically swap or exchange position when filter unit 110 is at capacity.

In yet another example, filter unit 110 may be designed to fit in an effluent discharge line of washing/drying machine 105. In this configuration, filter unit 110 may be designed with integrated or separate flow sensors, pressure gauges or other indicators to help ensure conditions for continuous flow, such as sufficiently low pressure and lack of backflow. These indicators may be included as part of filter unit 110 or may be part of a surrounding housing and not directly on filter unit 110.

Filter unit 110 may be positioned within washing/drying machine 105 for use during washing/drying cycles. Filter unit 110 may be removably attached to washing/drying machine 105 via one or more methods, including magnets, clamps, hooks, screws, tape, suction cups, glue, or snaps, or placed with or around the clothes. Filter unit 110 may be strategically placed within the agitator or impeller hub of a top-loading machine for ease of access and maintenance. In other examples, filter unit 110 may be located in any section of the drum, washing tub, lid, or door seal, or extending from or along the fins of a center impeller. In even further examples, filter unit 110 may be located in the water supply hose, drain hose, stacking kit, along the pedestal, lint filter bag, detergent dispenser, or accessories used alongside washing/drying machine 105. The placement of filter unit 110 may be optimized to balance maximizing debris capture and minimizing disruption to water flow and machine performance and may further be optimized to take advantage of spin direction of washing/drying machine 105 for best capture of microplastics.

In another embodiment, filter unit 110 may be placed outside of the washing/drying machine 105, in the drain hose, discharge water line, air exhaust line, or effluent pipe. Filter unit 110 may be located at the juncture of washing/drying machine 105, before the drain hose, discharge water line, air exhaust line, or effluent pipe or after it. This configuration may be a preferred location for commercial locations with multiple washing/drying machines 105. In some examples, multiple filter units 110 may be used to scale up for increased volume of processed effluent, for example in a modular fashion that allows for increased flow.

Multiple filter units 110 may be connected in a modular fashion using one or more approaches, to ensure seamless integration and interchangeability of modules or units. The choice of approach will depend on various factors, such as the size and shape of filter unit 110, the materials of construction, and the specific requirements of the filtration system. Multiple filter units 110 may be connected in a modular fashion using one or more approaches, including but not limited to: screw or bolt attachments that may use screws or bolts to connect multiple filter units 110 and hold them securely in place, rail systems that may allow multiple filter units 110 to slide and connect easily onto rails, clip-on or snap-in mechanisms for quick and easy connection of multiple filter units 110 without requiring additional tools, magnetic connections that may use magnets to hold multiple filter units 110 together (this approach may be particularly useful for large or heavy units), interlocking mechanisms that may allow multiple filter units 110 to fit together like puzzle pieces, with the interlocking portions holding multiple filter units 110 in place, or alternatively interchangeable modules that may be designed to add or modify functionalities easily.

In further examples, standardized connection for multiple filter units 110 may be achieved with a plug-and-play architecture, ensuring easy connection and disconnection between multiple filter units 110 without requiring configurations or adjustments, or a magnetic attachment may be used to connect multiple filter units 110 securely and effortlessly, enabling users to swap or upgrade an individual filter unit 110 with ease. A slide-in/slide-out mechanism may facilitate easy insertion and removal of multiple filter units 110 from designated slots, or utilizing snap-fit components may securely hold multiple filter units 110 in place while allowing quick and tool-less installation or removal. A modular backplane may provide a standardized interface for connecting multiple filter units 110 together, or a docking station may allow multiple filter units 110 to be docked onto washing/drying machine 105, ensuring seamless integration of functionalities. Wireless connectivity may enable multiple filter units 110 to connect to washing/drying machine 105 without physical connections, allowing for greater flexibility in filter unit 110 placement, or designing the device with software-configurable filter units 110 may allow users to activate or deactivate specific functionalities through software settings. Hot-swapping capabilities may enable users to add or remove multiple filter units 110 while the device is operational, without the need for powering off or rebooting, expansion slots, bays, or “daisy chaining” may provide convenient spaces for users to insert additional multiple filter units 110, extending its capabilities. Tool-less assembly may ensure users can attach or detach multiple filter units 110 without specialized tools, or using modular frames may allow multiple filter units 110 to be easily attached or detached. Universal mounting points or rails may accommodate different multiple filter units 110 with standard dimensions, facilitating easy installation, or employing color-coded connectors may simplify identification and connection of multiple filter units 110. Implementing latch or lock mechanisms may securely hold multiple filter units 110 in place while allowing for easy removal when needed, or quick-release mechanisms may facilitate swift removal and replacement of multiple filter units 110, or clearly labeling each filter unit 110 and its functionality may allow for easy identification and selection. A modular power supply system may enable different multiple filter units 110 to draw power independently if needed, enhancing flexibility and efficiency, or designing multiple filter units 110 that can be used across multiple washing/drying machines 105 may enhance versatility. Creating multiple filter units 110 that can be used interchangeably with various compatible washing/drying machines 105, regardless of the manufacturer, may improve compatibility, or offering swappable multiple filter units 110 may allow users to easily attach or detach them to suit different facilities. This will allow users to customize the arrangement and configuration of multiple filter units 110 based on their specific needs and may provide a personalized user experience. Incorporating a central control unit or base unit may allow building off it while it manages and communicates with various multiple filter units 110 to ensure seamless integration and operation. Enabling synchronization and communication between multiple groups of filter units 110 may enhance collaborative capabilities, or implementing modular user interfaces that adapt based on the connected multiple filter units 110 may present relevant controls and information, or providing expandable multiple filter units 110 may increase storage capacity as needed. Designing multiple filter units 110 that combine multiple functionalities may reduce the number of individual components, pivot or hinge connections may be suitable for multiple filter units 110 that may need easy opening or closing for maintenance or replacement, or threaded connections may involve using threads to connect multiple filter units 110 together. Flange connections may use a flat, wide surface to connect multiple filter units 110, or bayonet mounts may involve using a twisting motion to lock multiple filter units 110 together, quick connect/disconnect couplings may allow for easy and quick connection and disconnection of one or multiple filter units 110, facilitating maintenance and replacement, or other potential approaches for modular connection of multiple filter units 110 may include adhesive bonding, friction fitting, or pressure fitting. Note that any of the above connection or attachment mechanisms may also be used with a single filter unit 110.

In yet another embodiment, filter unit 110 is placed with or around the clothes inside the drum of washing/drying machine 105. In this case, filter unit 110 attracts fibers via different methods such as static electricity.

Filter unit 110, after it has been used in washing/drying machine 105, may reach a point where it can or should be removed, and a replacement for filter unit 110 should be installed. Indicators to determine that filter unit 110 can or should be exchanged may include sensors to measure pressure drop or flow rate, visual inspection, image analysis using cameras, optical measurements, ultrasound, sensors to detect transparency (or lack of transparency), overflow detection, electrical resistance, chemical reaction, or color change. In other examples, indicators that filter unit 110 should be exchanged may be based on numbers of wash cycles completed or may utilize a physical “button” indicator that changes position when filter unit 110 is full. In further examples, filter unit 110 may be integrated into operations of a “smart” or connected washing/drying machine 105, and may send messages or status of the filter for a user or in a commercial setting, to a building manager via Wi-Fi, text, email, SMS, or may present change in status via a physical indicator such as a light that is on or off, or changes color. Additional notification methods may include mobile app notifications, using smart home integration such as Alexa or Google Home, push notifications on a computer, receiving smart watch notifications, monitoring a web dashboard, phone calls or automated voice messages, or receiving social media notifications. Status information from filter unit 110 may be further integrated into performance analysis of washing/drying machine 105 and may calculate effective removal of microplastics and the resulting benefit, which may be communicated through reports, apps, or other home or building management software. In other examples, where filter unit 110 is made of multiple filter chambers, some or all chambers or its contents may be removed, or may have a sealed disposal container to be removed from washing/drying machine 105. This example may be particularly suited for commercial operation where extended use and reduced requirement for maintenance may help to contain cost.

Filter unit processor 125 is an industrial or technological system designed to efficiently process filter unit 110 by separating the microplastics from filter unit 110 and using the recovered microplastics to create a reusable new product. Filter unit processor 125 may utilize multiple methods to achieve separation of the microplastics from filter unit 110, including but not limited to use of physical, chemical, biological, or energy-based approaches, or any combination of these approaches, to eliminate, or separate other components of filter unit 110 from the microplastic content.

In one example, filter unit processor 125 may use physical approaches such as washing, sieving, shaking, chopping, shredding, filtering, pressurizing, spinning/centrifuging, or buoyancy/flotation techniques. In another example, filter unit processor 125 may use chemical approaches such as pulping, solubilizing, coagulating, flocculating. In yet another example, filter unit processor 125 may use a nature-based, biological or biomimicry approaches, including but not limited to use of enzymes, bacteria, or fungi to help separate or breakdown filter unit 110 or the captured materials into usable fractions or components. In yet another example, filter unit processor 125 may use energy-based approaches such as heat (e.g., pyrolysis) or lasers. In some examples, filter unit processor 125 may further use any of the above processes to separate natural fibers from microplastics if needed for certain applications.

Depending upon the processing used for separation of microplastics from filter unit 110, a specific choice of fabrication technologies may be made to create a new product. Filter unit processor 125 may use additional physical, chemical, biological, or energy-based approaches as described above, to prepare the material for creating a new product. In one example, filter unit processor 125 may use molds, stencils, weaving, injection molding, blow molding, extrusion, rotational molding, thermoforming, compression molding, transfer molding, injection blow molding, foam molding, film blowing, vacuum forming, reaction injection molding (RIM), structural foam molding, gas-assisted injection molding, co-extrusion, overmolding, insert molding, hot plate welding, ultrasonic welding, spin welding, vibration welding, laser welding, heat staking, thermochemical welding, solvent bonding, adhesive bonding, compression blow forming, continuous compression molding, in-mold labeling (IML), in-mold decoration (IMD), reaction injection blow molding (RIBM), foam-in-place gasketing, fiber reinforced plastic (FRP) molding, resin transfer molding (RTM), vacuum infusion process (VIP), pultrusion, filament winding, sheet lamination, solid phase forming, laser sintering, selective laser melting (SLM), stereolithography (SLA), fused deposition modeling (FDM), thermochemical compression molding, injection compression molding, electroforming, electrostatic discharge (ESD) protection coating, dip coating, powder coating, plating. 3D printing/additive fabrication or other methods, materials, and processes to create new products.

In another example, filter unit processor 125 may combine recovered microplastic content with other materials to achieve specific product characteristics such as strength, flexibility, or pliability in the new product, such as woven, knit, fabric, textiles, natural, or manmade fibers. Natural fibers may include walnut or coconut fibers, plant/cellulose, cotton, hemp, linen/flax, sinew, abaca, jute, bamboo, banana, ramie, sisal, coir, pineapple, wood, mohair, cashmere, leather, wool, silk, camel, alpaca, angora, yak, or other materials. Manmade fibers may include: natural polymer fiber, viscose, rayon, acetate, cupro, lyocell, modal, polynosic, synthetic polymer fiber, polyester, polyamide, carbon fiber, polyethylene, elastane, nylon, acrylic, fleece, satin, spandex, microfibers, aramid, polyethylene (PE), polypropylene (PP), polyvinyl chloride (PVC), polystyrene (PS), polyethylene terephthalate (PET), polyurethane (PU), acrylonitrile butadiene styrene (ABS), polycarbonate (PC), polyamide (PA) or nylon, polyethylene oxide (PEO), polybutylene terephthalate (PBT), polymethyl methacrylate (PMMA) or acrylic, polyvinylidene fluoride (PVDF), polyvinyl acetate (PVA), ethylene vinyl acetate (EVA), polyoxymethylene (POM) or acetal, polyphenylene oxide (PPO), polyphenylene sulfide (PPS), polyether ether ketone (PEEK), polyetherimide (PEI), polyimide (PI), polyethylene chlorotrifluoroethylene (ECTFE), polyethylene chlorinated (CPE), thermoplastic elastomers (TPE), thermoplastic polyurethane (TPU), fluoropolymers (e.g., PTFE, FEP, PFA), silicone rubber, melamine formaldehyde (MF), phenolic resin, epoxy resin, urea formaldehyde (UF), unsaturated polyester resin (UPR), melamine resin, polysulfone (PSU), polyether sulfone (PES), polyethersulfone (PESU), polyaryletherketone (PAEK), polyphthalamide (PPA), liquid crystal polymer (LCP), polyactic acid (PLA), or other materials.

In a separate embodiment, filter unit 110 may be used “as-is” without separation and processing based on the design and operation of filter unit 110.

Reconditioned filter unit 130 is the resulting product of the steps taken by filter processor 125 upon filter unit 110 to create a new product for sale or use. The term “reconditioned” may be broadly defined, including but not limited to mean: refurbished, renewed, restored, rehabilitated, remodeled, rebuilt, overhauled, repaired, revamped, upgraded, recertified, renovated, fixed, improved, reconstructed, repurposed, recycled, upcycled, reclaimed, salvaged, restituted, reutilized, reemployed, reassembled, reconfigured, reestablished, reinstated, reconstituted. Reconditioned filter unit 130 may be a filter ready for use in washing/drying machine 105, and may be the same style, size, or design as filter unit 110, but may be another style, size, or design for a different model of washing/drying machine 105, based on demands and manufacturing needs. Reconditioned filter unit 130 may be provided for sale to consumers or companies, may be part of a service or subscription model to provide replacements for filter unit 110 as needed for home consumers or commercial laundry operators, or may come pre-installed in washer/dryer unit 105.

New microplastic-containing product 135 is an item made with recycled material captured in filter unit 110 via filter unit processor 125. New microplastic-containing product 135 may specifically be another filter unit; however, new microplastic-containing product 135 may also be feedstock for other manufacturing processes that can utilize microplastics, including, but not limited to, consumer products such as packaging, construction products, insulation, stuffing, additive printing filament, furniture, clothing, carpets and rugs, toys, garden and outdoor products, stationery and office supplies, electronic accessories, sports equipment, homeware and kitchenware. In other examples, new microplastic-containing product 135 may be used in processing or manufacturing for cosmetics and personal care products, pharmaceuticals and healthcare, consumer electronics, telecommunications, energy and power generation, transportation and logistics, textiles and fabrics, recycling and waste management, advertising and marketing, education and school supplies, petrochemical industry, chemical manufacturing, oil and gas industry, mining and extraction, renewable energy, research and development, or environmental services.

Microplastic content separated from filter unit 110, or the entire filter unit 110, may be processed for more environmentally friendly disposal as microplastic matrix-fixed waste product 140. Microplastic matrix-fixed waste product 140 may be created by using different means such as but not limited to treating, binding, encapsulating microplastic content or combining it with other components to limit or prevent leakage or escape of microplastic back into the environment or from disposal location 140. The objective may be to allow safe disposal without leaching or other escape of microplastic, or complete recycling of the matrix with captured material. In one example, microplastic content separated from filter unit 110 may be processed into microplastic matrix-fixed waste product 140 using processes and technologies such as but not limited to thermal treatment, chemical binding or chemical treatment, biochar binding, microbial degradation, magnetic binding, solvent-based technologies, polymer encapsulation, coating, mechanical recycling, chemical recycling, fiber blending, fiber-to-fiber recycling, fiber-to-fabric recycling, upcycling, closed-loop recycling, reuse and resale, shoddy recycling, thermal recycling, industrial recycling, product take-back programs, recycled textile fiber, feedstock recycling, energy recovery, pyrolysis, gasification, solvent-based recycling, depolymerization, biodegradation, mechanical sorting, hybrid recycling, source reduction, plastic-to-fuel, mechanical reclamation, design for recycling, or vitrification.

Disposal location 145 is a designated site for the disposal of waste materials, and may be called a landfill, dump, rubbish dump, waste disposal site, garbage dump, tip, junkyard, refuse site, midden, dumpsite, waste facility, recycling facility, or Materials Recovery Facility (MRF). Disposal location 145 may be situated in or on a specially engineered area. Disposal location 145 may be a sanitary landfill, which may have a protective lining to prevent contamination of groundwater and may further emit gases for conversion to energy. Disposal location 145 may be an inert waste landfill for non-reactive wastes like concrete, bricks, and asphalt, or also may be a secure chemical landfill designed to safely isolate hazardous waste. In one embodiment, disposal location 145 employs the use of biological, nature-based and/or biomimicry solutions to help breakdown waste materials.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

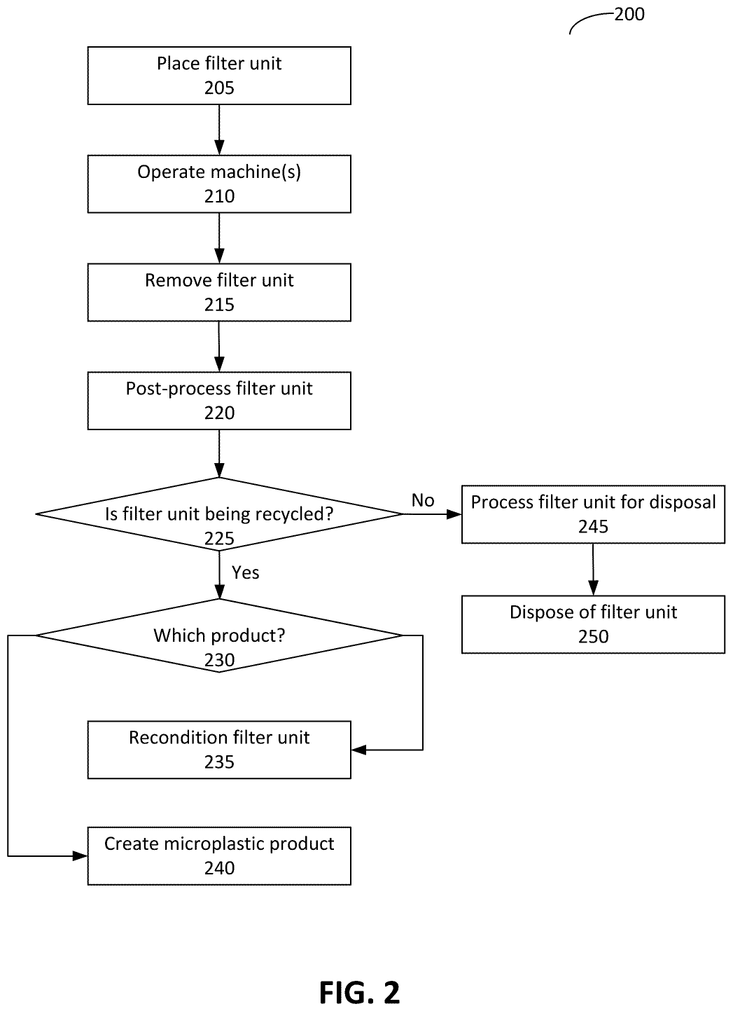

FIG. 2 displays a method 200 of operating a closed loop system for capture and recycling of microplastics.

The process begins with placing, at step 205, filter unit 110. In this step, filter unit 110 is placed in washing/drying machine 105 for use. Filter unit 110 may be housed, contained, enclosed, accommodated, sheltered, stored, secured, situated, placed, or held in a frame for ease of handling and placement. The frame may also be described as a casing, canister, enclosure, container, shell, cover, chassis, body, or box. Filter unit 110 may be strategically placed within the agitator or impeller hub of a top-loading machine for ease of access and maintenance. In other examples, filter unit 110 may be located in any section of the drum, washing tub, lid, or door seal, or extending from or along the fins of a center impeller. Placement of filter unit 110 may be optimized to balance maximizing debris capture and minimizing disruption to water flow and machine performance and may further be optimized to take advantage of spin direction of washing/drying machine 105 for best capture of microplastics.

In another embodiment, filter unit 110 may be placed outside of the washing/drying machine 105, including but not limited to in the drain hose, discharge water line, air exhaust line, or effluent pipe. Filter unit 110 may be located at the juncture of washing/drying machine 105, before the drain hose or after it. This configuration may be a preferred location for commercial locations with multiple washing/drying machines 105. In some examples, multiple filter units 110 may be used to scale up for increased volume of processed effluent, at step 205. In certain instances, step 205 involves using multiple filter units 110 either as a base unit or as multiple units, employing any of the pre-described approaches, in a modular fashion to scale up and accommodate a higher volume of processed effluent. This scalable approach allows for the integration of additional filter units 110 to handle larger quantities of wastewater efficiently and effectively. The utilization of the pre-described modular connection methods ensures seamless integration and interchangeability of filter unit 110, enabling easy expansion or customization of the filtration system based on specific needs and increasing the overall capacity for processing effluent.

Operating, at step 210, washing/drying machine. In this step, washing/drying machine 105 is used to wash textile, and/or dry textile, while filter unit 110 filters microplastics from the aqueous or atmospheric effluent, at step 210. In one embodiment, washing/drying machine 105 and filter unit 110 are designed to help prevent damage to washing/drying machine 105 in the event that filter unit 110 is clogged. In one example, washing/drying machine 105 has an emergency shutoff upon detection of high pressure or resistance across filter unit 110 via a sensor. In another example, washing/drying machine and filter unit 110 are designed with a physical diversion to divert all or some of the flow around or away from filter unit 110, in order to prevent damage to washing/drying machine 105.

Removing, at step 215, filter unit 110. In this step, filter unit 110 is removed from washing/drying machine 105, based on at least one determinant that the filter unit 110 should be removed and changed. Status information from filter unit 110 may be further integrated into performance analysis of washing/drying machine 105 and may calculate effective removal of microplastics and the resulting benefit, which may be communicated through reports, apps, or other home or building management software. In one example, filter unit 110 is removed from the frame containing it, and in another example, the entire assembly of the frame and filter unit 110 may be removed together. After filter unit 110 is removed (with or without the frame), it may be transferred to a filter unit processor 125. The transfer may be designed as a reverse logistics process for a company to collect and recycle filter unit 110, such as a closed loop process between an industry, distributor, retail, end user, collection and selection, recycling, and back to the industry. This transfer may occur by dropping off filter unit 110 at a designated collection point, by mailing filter unit 110 to the filter unit processor 125 or having a form of pickup service to collect filter unit 110 from the home or commercial location. In another example, the customer may elect for filter unit 110 to be disposed of through the collection process, at step 215.

Post-processing, at step 220, filter unit 110. In this step, filter unit processor 125 processes filter unit 110 for a designated purpose, which may include being recycled into a reconditioned filter unit 130, being recycled into a new microplastic-containing product 135, or being processed for disposal into a microplastic matrix-fixed waste product 140. Recycling may consist of activities including, but not limited to washing, sorting, shredding, granulating, melting, extrusion, pelletizing, injection molding, blow molding, film blowing, thermoforming, compounding, pyrolysis, gasification, depolymerization, mechanical recycling, chemical recycling, feedstock recycling, and energy recovery. Specifically, filter unit 110 may be processed via one or multiple of the following treatment technologies, which may be determined by the choice of end product:

One potential technology for dealing with microplastics is thermal treatment. Methods such as pyrolysis or thermal desorption can encapsulate microplastics by using heat to break down plastic materials into their base components. Following this, a matrix of another material, such as a polymer or cement, can contain the resulting substance and prevent the escape of microplastics.

Chemical treatment is another feasible method. It often involves altering the surface chemistry of microplastics to make them more adhesive, which allows them to be easily bound or encapsulated. For instance, silane treatment can change the surface chemistry of microplastics, enabling them to bind to other substances.

Solvent-based technologies can be utilized to deal with microplastics as well. These technologies dissolve plastics into a solvent, thereby transforming them into a form that can be more easily managed and contained. The dissolved plastic can then be incorporated into a matrix or contained in other ways to prevent it from escaping into the environment.

Polymer encapsulation is another technique that can be employed. Specific polymers can be designed to encapsulate microplastics, effectively entrapping them within a larger matrix. This could involve embedding the microplastics in polymeric capsules or forming a polymeric matrix in which the microplastics are distributed. The resultant material could then be used in a controlled manner to prevent the release of microplastics.

Some methods involve mixing microplastics with a magnetic substance, such as a ferrofluid, and then using magnets to collect and concentrate the microplastics. Once bound with the magnetic substance, the microplastics could potentially be embedded within a matrix or encapsulated.

Certain chemicals can bind with microplastics, creating a solid matrix that can contain the microplastics. This could involve covalent bonding, ionic bonding, or other types of chemical reactions.

Biochar, a type of charcoal produced by pyrolysis of biomass, has been shown to have a strong affinity for microplastics, binding with them and preventing their spread. The microplastics could be embedded within the porous structure of the biochar, keeping them contained.

Vitrification, which is commonly used in the management of hazardous waste, is a process where a material is heated until it melts, then cooled so rapidly that it solidifies without crystallizing, forming a glass-like substance. This could be used to trap microplastics in a glassy matrix, preventing them from being released. This method is commonly used for the treatment of high-level radioactive waste, but it could potentially be adapted for microplastics.

In one embodiment, filter unit 110 may be processed in a minimal manner, such as washing or separation, if appropriate for the designated end use.

In another embodiment, filter unit 110 may be processed multiple times through filter unit processor 125 until the microplastic can no longer be reused due to chemical degradation. In one example, after filter unit 110 has reached its limit on recycled use, the microplastic content separated from filter unit 110 is instead processed into microplastic matrix-fixed waste product 140 for more environmentally friendly disposal, using one of the approaches described above, at step 220.

In a decision step 225, is filter unit 110 being recycled? In this step, it is determined whether filter unit 110 will be recycled into a new product or will be processed for disposal. The determination may be made by business factors such as market demand or market pricing of recycled microplastic materials or may be made by technical factors such as cost to process filter unit 110 and create a new product, vs cost of processing for disposal. In an alternate example, the user may choose the disposition of filter unit 110 based on choices offered through a subscription model and associated cost structure. If filter unit 110 is to be recycled into a new product, method 200 continues to step 230. If not, method 200 continues to step 245.

Determining, at step 230, a new product. In this step, it is determined whether filter unit 110 will be recycled into a reconditioned filter unit 130, or a new microplastic-containing product 135. If filter unit 110 will be recycled into a reconditioned filter unit 130, method 200 proceeds to step 235. If not, method 200 proceeds to step 240.

Creating, at step 235, a reconditioned filter unit 130. Any method or combination of methods described herein may be used to create reconditioned filter unit 130. In some examples, filter unit 110 may be removed from a frame for processing. The frame may be handled separately and may be reused, reconditioned, or disposed of. In other examples, filter unit 110 may be processed together with the frame. In yet other examples, the user may have already removed filter unit 110 from the frame before transferring to filter unit processor 125. In even further examples, microplastic material may be included as part of reconditioned filter unit 130 to improve or aid in the function of filtration media. In this step, filter unit 110 may be processed by filter unit processor 125 into a reconditioned filter unit 130. Method 200 ends.

Creating, at step 240, a new microplastic-containing product 135. In this step, filter unit 110 may be processed by filter unit processor 125 into a new microplastic-containing product 135. Method 200 ends.

Processing, at step 245, the filter unit 110 for disposal. In this step, filter unit 110 may be processed for disposal as a microplastic matrix-fixed waste product 140. In some examples, filter unit 110 is processed by filter unit processor 125. In other examples, the user may have the ability to process filter unit 110 and transfer microplastic matrix-fixed waste product 140 directly to disposal location 145. In yet another example, the user may be provided a container to safely transfer filter unit 110 to disposal location 145, where filter unit 110 is processed to become microplastic matrix-fixed waste product 140. Method 200 proceeds to step 250.

Disposing, at step 250, microplastic matrix-fixed waste product 140 at disposal location 145. In this step, filter unit 110 may be disposed in a landfill or similar location. Method 200 ends at step 250.

In one example of operation, filter unit 110 may be placed by a user inside the drum of a residential top-loading washing/drying machine 105, where a filter housing may be snapped into the holes of the inside drum and may be designed to house filter unit 110. The user may operate washing/drying machine 105 until it is time for the filter to be removed, exchanged, or cleaned. An indicator (such as a pressure sensor) may alert the user that the filter unit 110 has reached a recommended capacity of microplastics and other debris capture. The user may remove filter unit 110 and may send it in a provided prepaid container, as part of a recycling program, to filter unit processor 125. Filter unit processor 125 may physically chop, heat, and chemically treat filter unit 110 to manufacture reconditioned filter unit 130. Reconditioned filter unit 130 may be offered for sale or may be part of a subscription program for refills, to provide a replacement for filter unit 110 to a user, in order to be placed back in washing/drying machine 105 for further operation.

In a variation of the above example, filter unit 110, or multiple units, may be placed by a user in the effluent line or the air exhaust line of a commercial front-loading washing/drying machine 105, where filter unit 110 may be designed to confirm to the size and shape of the effluent line or the air exhaust line, to become filter unit 110. The user may operate washing/drying machine 105 until it is time for the filter to be removed, exchanged, or cleaned. An indicator (such as a pressure or flow sensor) may alert the user that the filter unit 110 has reached a recommended capacity of microplastics and other debris capture, thus becoming filter unit 110. The user may remove filter unit 110 (or multiple units) and may alert a business service that supplies the commercial operation to pick up the filter unit(s) 110 and deliver to filter unit processor 125. Filter unit processor 125 may physically chop, heat, and chemically treat filter unit 110 to manufacture reconditioned filter unit 130. Reconditioned filter unit 130 may be offered for sale or may be part of a subscription program for refills as filter unit 110, to provide a replacement for filter unit 110 to a user, in order to be placed back in a washing/drying machine 105 for further operation.

In a first alternate example of how filter unit 110 may be handled, filter unit processor 125 may opt to create a new filter unit 110 or a different product with filter unit 110, based on customer demand and market prices of microplastics. In that case, filter unit processor 125 may follow different processing steps to allow extrusion of the recovered microplastics into a new microplastic-containing product 135. Filter unit processor 125 may then provide the new microplastic-containing product 135 for direct sale to customers or may be a supplier in a B2B operation for a company that may purchase and use the new microplastic-containing product 135 as a feedstock for their process.

In a second alternative example, the user may opt to send filter unit 110 to filter unit processor 125 for disposal, which may have a different associated cost to the user, or a decision may be made that filter unit 110 can no longer be recycled and must be disposed. In that case, filter unit processor 125 may be treated chemically or with heat to fix the microplastics into a non-leaching substance of microplastic matrix-fixed waste product 140, and then sent to a disposal location 145, such as a landfill. The user may also opt to send filter unit 110 directly to a disposal location 145 without processing.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A system for capturing microplastics, the system comprising:
a filter unit including:
an attachment mechanism configured to couple to a mounting point of a machine associated with a flow of fluid, and
one or more filter cartridges each configured to removably attach to the attachment mechanism and to filter microplastic particles from the flow of fluid;
one or more sensors configured to monitor one or more conditions associated with the flow of fluid filtered by the filter cartridges and to determine a status of one or more of the filter cartridges of the filter unit based on the monitored conditions; and
a processor that executes software stored in memory to activate or deactivate one or more functionalities of the filter unit in accordance with the status.

2. The system of claim 1, wherein the filter unit further comprises a frame removably coupled to the attachment mechanism and comprising one or more slots each configured to hold one of the filter cartridges.

3. The system of claim 1, further comprising a magnetic or snap-fit attachment that connects one of the filter cartridges to another one of the filter cartridges.

4. The system of claim 1, wherein the filter cartridges are rotatable within a frame.

5. The system of claim 1, wherein the filter cartridges automatically swap positions within a frame based on a current capacity of one or more of the filter cartridges.

6. The system of claim 1, wherein the flow of fluid includes one or more of an effluent discharge line, air exhaust line, hose, or drain.

7. The system of claim 1, wherein the monitored conditions include a capacity of microplastic particles reached by the one or more filter cartridges, and further comprising a communication interface that sends a message regarding removal of the one or more filter cartridges to a designated recipient device based on the monitored conditions.

8. The system of claim 1, further comprising a physical indicator activatable to indicate when the monitored conditions indicate a change in status associated with the flow of fluid.

9. The system of claim 1, wherein the processor further executes software stored in memory to activate or deactivate the functionalities of the filter unit in accordance with changed settings.

10. The system of claim 1, wherein at least one of the filter cartridges includes a chamber configured to contain the microplastic particles filtered from the flow of fluid.

11. The system of claim 10, wherein the microplastic particles are removable from the chamber, and wherein the at least one filter cartridge is reusable after the microplastic particles are removed from the chamber.

12. The system of claim 11, wherein the chamber includes a sealed disposal container that is removable from the at least one filter cartridge.

13. The system of claim 1, further comprising a rail onto which the filter unit may slide, and wherein the rail is configured for sliding a plurality of filter units.

14. The system of claim 1, further comprising a modular backplane configured to provide a standardized interface for connecting a plurality of filter units.

15. The system of claim 1, further comprising a filter unit processor configured to separate the filtered microplastics from the filter unit using one or more of physical, chemical, biological, energy-based separation mechanisms.

16. The system of claim 1, wherein the filter unit comprises a plurality of sections, wherein one of the sections is exposed to the microplastics at a time, and wherein the filter unit is one of a circle, loop, cone, wheel, elongated shape.

17. The system of claim 1, wherein the filter unit includes an extended capacity filter that is moved continuously based on one or more pre-established determinations.

18. The system of claim 1, wherein the filter unit includes an extended capacity filter that is moved independently of the sensors.

19. The system of claim 1, wherein data from the one or more sensors is used to determine an optimal time or condition to change, purge by back flushing, purge by mechanical scraping, or adjust the filter unit to engage an unused section of the filter unit.

20. The system of claim 1, wherein the conditions include one or more of pressure, pressure differential between different sides of the filter unit, flow rate, differential of flow rate, mass buildup on the filter unit, power input variation on pump motors, and time of active usage since a new state of the filter unit.
